(19) United States
(12) Patent Application Publication
(10) Pub. No.: US 2004/0062433 A1
(43) Pub. Date: Apr. 1, 2004

(54) Method to approximate section properties of mechnical elements through data obtained from digital images

(76) Inventor: William Paul, Jr. Munsell, Norman, OK (US)

Correspondence Address: William Paul Munsell, Jr., 2500 Ridgefield Drive, Norman, OK, 73069, US

(21) Appl. No.: 09/809,612

(22) Filed: Mar. 16, 2001

(51) Int. Cl. G06K 9/00

(52) U.S. Cl. 382/152

(57) ABSTRACT

A method to approximate section properties of mechanical elements in which data is drawn directly from digital images representing the cross-section in question. Both homogeneous and composite structures may be evaluated.

### BACKGROUND

Evaluating section properties such as moment of inertia is the basic first step in analyzing the strength and deformation of mechanical elements. The process of calculating these properties by hand can quickly become extremely complex, error-prone, and time-consuming with even small increases in the number of geometric irregularities in the section profile. CAD programs use complex mathematical models of the cross-section to achieve this and as a result incur high costs in software, hardware, and user skill level. These models are laborious to modify if small changes are desired. The object of the present invention is to provide an accurate method of deriving the section properties for simple as well as highly irregular cross-sections quickly in the office or in the field without hand calculation and without complex mathematical models and therefore without the expense of high-end hardware and software.

### SUMMARY

The proposed method for approximating section properties of a mechanical element manipulates data gathered directly from digital images that represent the cross-section in question. This makes the process quicker, eliminates human error, and is cost-efficient due to the stand-alone nature of the otherwise simple code required and the simple interface that requires no specialized programming, software, or engineering skills. A digital image of the cross-section is created by scanning the cross section, or scanning a sketch of the cross section, or creating the digital image with photo-editing software, or creating the image from sensor data, or obtaining the graphics file by other means. The digital image is then saved as a two-color image with one color signifying empty space. A computer program designed to accommodate the preferred graphics file type queries the image pixel-by-pixel for the color property. When preferred-color pixels are detected the pixel position data is recorded as x and y coordinates. In one preferred embodiment a 2×n array is created where n is the number of preferred-color pixels. However the data is arranged, standard engineering formulas adapted for use with the arrangement are then used to develop the section properties.

[image]

The standard engineering formulations adapted to the array:

$$\begin{matrix}A = area of each pixel , {in}^{2} \\ = ( \frac{1}{x res} ) ( \frac{1}{y res} )\end{matrix} \qquad ( 1 )$$

where xres and yres are the resolution of the digital image in pixels/inch

$$\begin{matrix}\begin{matrix}{I}_{cx}^{1} = the centroidal moment of inertia for each pixel about its \\ x axis , {in}^{4} \\ = \frac{( \frac{1}{x res} ) {( \frac{1}{y res} )}^{3}}{12}\end{matrix} & ( 2 ) \\ \begin{matrix}{y}_{c1} = the vertical distance between the centroid of each pixel \\ and the upper edge of the image , in \\ = \frac{1}{y res} ( {y}_{t} - .5 )\end{matrix} & ( 3 ) \\ \begin{matrix}{y}_{c} = the vertical distance between the upper edge of the image \\ and the centroid for the aggregate shape , in \\ = \frac{{\sum }_{i = 1}^{n} {A}_{i} {y}_{ci}}{{\sum }_{i = 1}^{n} {A}_{i}}\end{matrix} & ( 4 ) \\ = \frac{A {\sum }_{i = 1}^{n} {y}_{c1}}{n A} & ( 5 ) \\ = \frac{1}{n} {\sum }_{i = 1}^{n} {y}_{c1} & ( 6 ) \\ = \frac{1}{n \cdot y res} {\sum }_{i = 1}^{n} ( {y}_{t} - .5 ) & ( 7 ) \\ \begin{matrix}{d}_{y1} = the vertical distance between the centroid of each pixel \\ and the centroid of the aggregate shape , in \\ = {y}_{c1} - {y}_{c}\end{matrix} & ( 8 ) \\ \begin{matrix}{I}_{{cx}^{′}} = the centroidal moment of inertia of the aggregate shape \\ about its x axis , {in}^{4} \\ = {\sum }_{i = 1}^{n} ( {I}_{cx}^{1} + {A}_{i} {d}_{{y}_{1}}^{2} )\end{matrix} & ( 9 ) \\ = {\sum }_{i = 1}^{n} {I}_{cx}^{1} + A {\sum }_{i = 1}^{n} {d}_{{y}_{i}}^{2} & ( 10 ) \\ = {n I}_{cx}^{i} + \frac{A}{y {res}^{2}} {\sum }_{i = 1}^{n} {( {y}_{1} - .5 - \frac{1}{n} {\sum }_{i = 1}^{n} ( {y}_{i} - .5 ) )}^{2} & ( 11 )\end{matrix}$$

Likewise,

$$\begin{matrix}\begin{matrix}{I}_{{cy}^{′}} = the centroidal moment of inertia of the aggregate shape \\ about its y axis , {in}^{4} \\ = {nI}_{cy}^{1} + \frac{A}{x {res}^{2}} {\sum }_{i = 1}^{n} {( {x}_{i} - .5 - \frac{1}{n} {\sum }_{i = 1}^{n} ( {x}_{i} - .5 ) )}^{2} \\ where\end{matrix} & ( 11 a ) \\ = \frac{( \frac{1}{y res} ) {( \frac{1}{x res} )}^{2}}{12} & ( 2 a )\end{matrix}$$

This leads to the rest of the section properties such as radius of gyration, product of inertia, principal axes, polar moment of inertia, polar radius of gyration, plastic section modulus, etc. Accuracy is determined by the number of pixels used to define the cross-section and is adjustable by the user. In another permutation of the method, more than one preferred color may be recognized in the digital image to accommodate composite structures.

What is claimed is:

1. A method of approximating section properties of a mechanical element which comprises the steps of:
A. Obtaining or creating a digital image of the cross-section in question.
B. Querying the image file for the x,y coordinates of preferred-color pixels and image resolution.
C. Counting the number of preferred-color pixels
D. Arranging the data
E. Applying standard engineering formulations adapted for use with the arranged data to derive the desired section properties including area, moment of inertia, radius of gyration, product of inertia, principal axes, polar moment of inertia, polar radius of gyration, plastic section modulus, etc.

2. A method as in claim 1 where there is more than one preferred-color and each different color represents a different material and the whole forms a composite structure. Parallel sets of engineering equations may be used to evaluate each different material separately.
